(19) United States
(12) Patent Application Publication
(10) Pub. No.: US 2004/0040644 A1
(43) Pub. Date: Mar. 4, 2004

(54) Micro hot embossing method for quick heating and cooling, and uniformly pressing

(76) Inventors: Jer-Haur Chang, Changhua County (TW); Sen-Yeu Yang, Taipei (TW)

Correspondence Address: Samuels, Gauthier & Stevens LLP, Suite 3300, 225 Franklin Street, Boston, MA, 02110, US

(21) Appl. No.: 10/647,850

(22) Filed: Aug. 25, 2003

(30) Foreign Application Priority Data
Aug. 30, 2002 (CN) 02131969.3
Jun. 11, 2003 (TW) 92115879

(51) Int. Cl. B31F 1/00

(52) U.S. Cl. 156/209

(57) ABSTRACT

The present invention provides a micro hot embossing method, which can quick heat and cool, and uniformly pressing an object to be embossed. The object is laid on a mold and a sealing chamber is used to enclose the object and the mold. A high pressure fluid which has a temperature sufficient to heat the object to be thermoplastic is introduced into the chamber for heating and pressing the object. The present invention can quick heat and cool the object, emboss the object using a mold made of bristle material such as glass or silicon wafer, and uniformly press the object in a very large area.

### FIELD OF THE INVENTION

The present invention relates to a micro hot embossing method for replicating micro-structures, and more particularly to a micro hot embossing method for quick heating/cooling and uniform embossing, which can replicate microstructures formed on a mold to an object by applying a heated and pressurized fluid directly onto the object placed on the object.

### BACKGROUND OF THE INVENTION

Recently, development of various micro-electro-mechanical systems (hereinafter, called as MEMS) has attracted attentions worldwide. Such systems integrate various technologies such as optical, mechanical, electronics, material, control, and chemistry technologies. Exiting products can be further miniaturized by such technologies, and hence their performance, quality, reliability and added values can be improved with even reduced costs. MEMS will play an important role in various technical fields such as opto-electro communication, image transfer, bio-medicine, information storage, and precise mechanism.

In the MEMS field, the micro hot embossing method is an important technology for duplicating microstructures, which can duplicate microstructures formed on a silicon master board (stamper, master or mold) or a nickel-plated mold onto an object. Micro hot embossing can manufacture products with high precision and quality. Such fabricated products can be sliced into parts with microstructures. They can be used as components or be further treated by other processes. Here, the dimension for the called microstructure is scaled in μm or nm.

The micro hot embossing method can be widely applied to fabrication of micro optical elements such as micro lens, grating, and diffractive optical elements, of micro bio devices such as bio-chip, micro channel, and micro sensors, of micro mechanical elements such as thin walls, micro grooves, and micro gears, or of integration of microelectronics and microstructures such as micro acceleration gauges. This technology is considered as an important process for reducing cost and improving productivity for the micro-electro-mechanical industry.

Generally, the hot embossing process mainly includes preparing, heating, embossing, cooling, and de-molding steps. For example, for embossing an object made of plastic material, the object will be placed on a mold (preparing step) and heated to or above its glass transition temperature to become a softened state (heating step). Then pressing platens are driven to press the object against the mold so that the soft plastic material will be forced into micro in the mold (embossing step). After the cavities are filled with plastic material, the stack of the object and the mold is cooled down (cooling step), in which the plastic material shrinks as the temperature is lowered, and spaces emptied due to shrinkage of the material inside cavities is refilled with other plastic material outside cavities under the sustained pressing force. After the temperature is lowered below the transient temperature, the mold is separated from resultant products (de-molding step).

This known hot embossing method uses a hydraulic or pneumatic cylinder or motor/a screw for driving the pressing platens to press the plastic object against the mold so as to replicate microstructures on the mold onto the object. An example of the conventional embossing method is shown in FIG. 6, in which a mold 102 is securely hold on an upper pressing platen 103a, a layer of soft material (silicon rubber) is put on the mold 102, and an object of plastic material 101 is placed on a lower platen 103b. A heating/cooling device 105 may be provided in the pressing platens 103a and 103b for heating and cooling the assembly of the object 101 and the mold 102. Subsequently, the assembly of the object 101 and the mold 102 is pressed by the pressing platens, which are driven by a hydraulic or pneumatic cylinder or motor/the screw 106. After being pressed for a time period, the assembly is cooled down and opened. The mold 102 is opened for taking out resultant products.

Conventional micro embossing methods which use the pressing platens are disclosed in U.S. Pat. No. 5,993,189, and DE 196,48,844 assigned to JENOPTIK Mikrotechnik company, Germany.

Since the known pressing platens are also provided with functions for heating/cooling, they are also called as “hot plate”. During the heating step, a heater or heating conduit 105 provided inside the pressing platen will heat the whole hot plate first, and then the heat is transferred to the mold 102 and the object 101 placed on the pressing platens by conduction to heat the object to its softening temperature for embossing. During the cooling step, a cold fluid will be introduced into the conduit 105 to cool down the whole plate first and then the object. Such heating/cooling methods have to first raise or lower the temperature of the whole pressing platen, and thus it will take about tens of minutes to few hours. It is a time-consuming and energy-costly process. In comparison with other technologies for replicating microstructures such as micro-injection or molding methods, the known hot embossing technologies are inefficient. Therefore, the conventional hot embossing methods have a drawback of high cost for process time.

Incidentally, according to the known methods, since the distribution of the applied pressure for embossing between the pressing platens is higher in its central zone but lower in its edge zone. A silicone rubber plate functioning as a soft pad is interposed between the mold and the object so as to reduce adverse influences caused by non-uniform distribution of pressure. However, the embossing pressure still can not be uniformly distributed even if the silicon rubber is used, because the rubber is easily deformed due to stretch. The non-uniform distribution of applied pressure will cause uneven filling when micro cavities are filled with melted plastic material. The non-uniform distribution of pressure will further result in non-uniform shrinkage of the material during the cooling step, and thus reduces the overall accuracy of resultant products. As a result, these conventional micro hot embossing methods are striving to manufacture micro-electro-mechanical products with high precision and quality and yield.

Upon embossing an object such as a plate of a large area, such non-uniform distribution of pressure will become even more serious. In addition, such pressure nonuniformity can easily cause cracks in a mold made of brittle materials such as glass, silicon wafer, etc. Therefore, the effective working area for these conventional methods is small. For example, the largest working area of a commercial hot embossing machine (model HEX-03, made by Jenoptik, Germany) is limited to 130 mm.

In addition, as the large-sized wafer size such as 12 inches are common in the semiconductor industry, a novel micro hot embossing method with rapid heating/cooling and uniform emboss pressing large-area is demanded for improving the productivity and reducing the cost per unit area for silicon-based MEMS.

### SUMMARY OF THE INVENTION

In light of the above, the present invention provides a novel micro hot embossing method which can rapidly heat/cool and uniformly apply pressure onto an object to be embossed.

One object of the present invention is to provide a hot embossing method, which can quick heat/cool and apply uniform pressure onto an object being closely placed against a mold in a sealed chamber, the method being characterized in that the sealed chamber is separated into a first space and a second space by the object in such a manner that the object and the mold are inside the second space, and a high pressure fluid is introduced into the first space when the object is heated to be thermoplastic, thereby to replicate a microstructure formed on the mold onto the object by means of pressing the object by the high pressure fluid without using any pressing mechanism.

Another object of the present invention is to provide a hot embossing method for forming microstructures onto both surfaces of an object, which can quick heat/cool and apply uniform pressure onto an object, the method being characterized in that the object is sandwiched by two separate molds to form an assembly to be embossed, a sealing film covers the assembly, a chamber presses against the edge parts of the sealing film to enclose the sealing film and the assembly therein in such a manner that a space inside the chamber is separated into a first space and a second space by the sealing film and the assembly is positioned inside the second space, and a high pressure fluid is introduced into the first space when the object is heated to be thermoplastic, thereby to simultaneously replicate the microstructures of the two molds onto both surfaces of the object by pressing the assembly by the high pressure fluid without using a pressing mechanism.

In addition, according to the present invention, the object may be heated to be thermoplastic by the high pressure fluid which is heated to a temperature higher than a glass transient temperature of the object before being introduced into the chamber.

Further, according to the present invention, in a case the introduced fluid is a gas, the object may be heated to be thermoplastic by a radiation heater such as a far infrared heater, a high frequency heater, an UV heater, and a halogen heater, before it is uniformly pressed by the high pressure gas.

Still according to the present invention, a coolant such as liquid nitrogen may be introduced into the chamber for quick cooling the assembly to be embossed, after the high pressure fluid is introduced into the chamber for a time period.

The high pressure fluid has a pressure ranged from 0.5 kgf/cm² to 350 kgf/cm² for the embossing operation, and the pressing time for pressing the assembly is between 10 seconds and 30 minutes.

Since the present invention uses the heated and pressurized fluid for embossing, the embossed area of an object is very large but the embossing precision is very high owing to the uniform distribution of pressure of fluid properties. Further, the present invention can avoid the long heating/cooling time required by the conventional technologies, and provide a simplified, efficient and low cost embossing process, because the temperature of the pressurized fluid is raised sufficient to heat the object to be thermoplastic.

### BRIEF DESCRIPTION OF THE DRAWINGS

The above and other objects, advantages, and features of the present invention will be more apparent from the following explanation with reference to accompany drawings, wherein:

FIGS. 1(a) to 1(d) illustrate operations for molding microstructures according to the first embodiment of the present invention;

FIGS. 2(a) to 2(d) illustrate operations for molding microstructures according to the second embodiment of the present invention;

FIGS. 3(a) to 3(e) illustrate operations for molding microstructures according to the third embodiment of the present invention;

FIG. 4 illustrates a heating/cooling apparatus provided in a chamber, which is used to perform the heating or cooling step according to the embodiments of the present invention;

FIG. 5 shows a radiation heater used for heating the object according to embodiments of the present invention; and

FIG. 6 shows an example of a conventional hot embossing method.

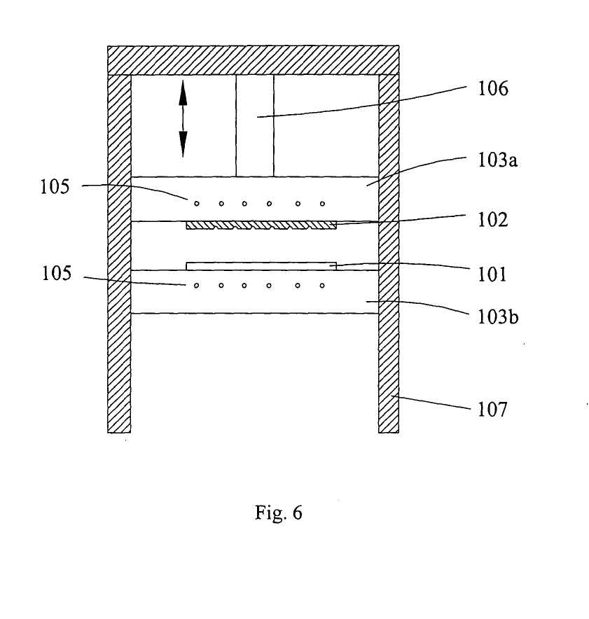

### DETAILED DESCRIPTION OF THE PREFERRED EMBODIMENT

Embodiment 1

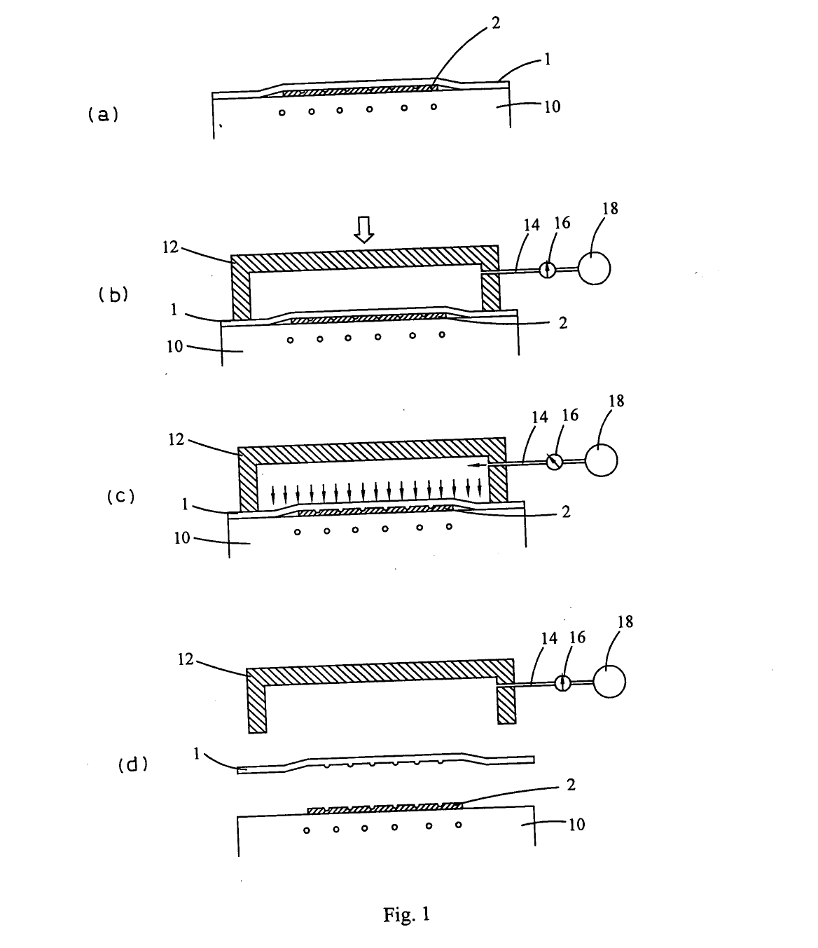

FIGS. 1(a) to 1(d) show steps for molding microstructures according to the first embodiment of the present invention. As shown in FIG. 1(a), on a platform 10, an object 1 such as a plastic film (PC film) is laid on a mold 2 so as to contact one surface of the mold 2 on which a predetermined microstructure is formed. For example, the mold 2 may be made of a brittle material such as silicon or glass.

Subsequently, as illustrated in FIG. 1(b), a chamber 12 is used to enclose the plastic film 1/mold 2 stack so as to form a sealed space. The chamber 12 is driven by hydraulic means or a crank (not shown) so as to be quick closed or opened. The chamber 12 is connected to a pressure control valve 16 and a pressurized fluid source 18 via a conduit 14. The pressurized fluid source 18 be able to supply a heated and pressurized fluid. The fluid may be, for example, a gas such as inert gas or a liquid such as oil.

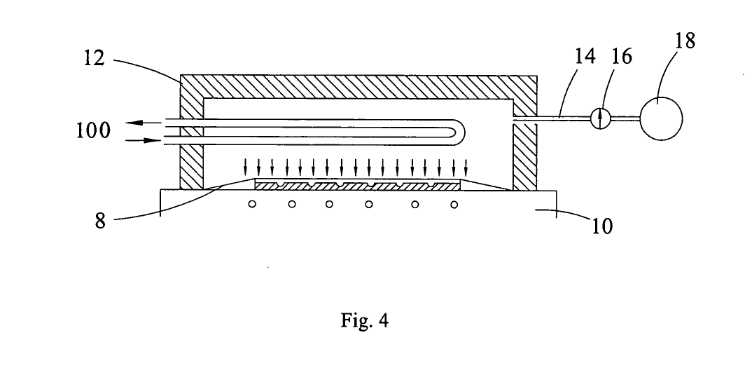

The heated and pressurized fluid is then regulated by the pressure control valve 16 up to a pressure sufficient to emboss the plastic film 1, for example, 0.5 to 350 kgf/cm², as shown in FIG. 1(c). Since the temperature of the pressurized fluid is high enough to heat the plastic film 1 to its glass transient temperature or above, the plastic film 1 is heated to become thermoplastic by the heated and pressurized fluid being introduced into the chamber. The plastic film 1 which became soft fills into cavities in the mold in the pressurized fluid for a time period, and then is cooled, while sustaining the pressure of the fluid substantially constant. During the cooling step, as shown in FIG. 4, a coolant such as cooling water may flow through the conduit 100 provided in the platform or the chamber.

After filling cavities with soft plastic material to form a desired device, the fluid will be drained out, and then the chamber is opened for taking out the resultant product. (As shown in FIG. 1(D))

Embodiment 2

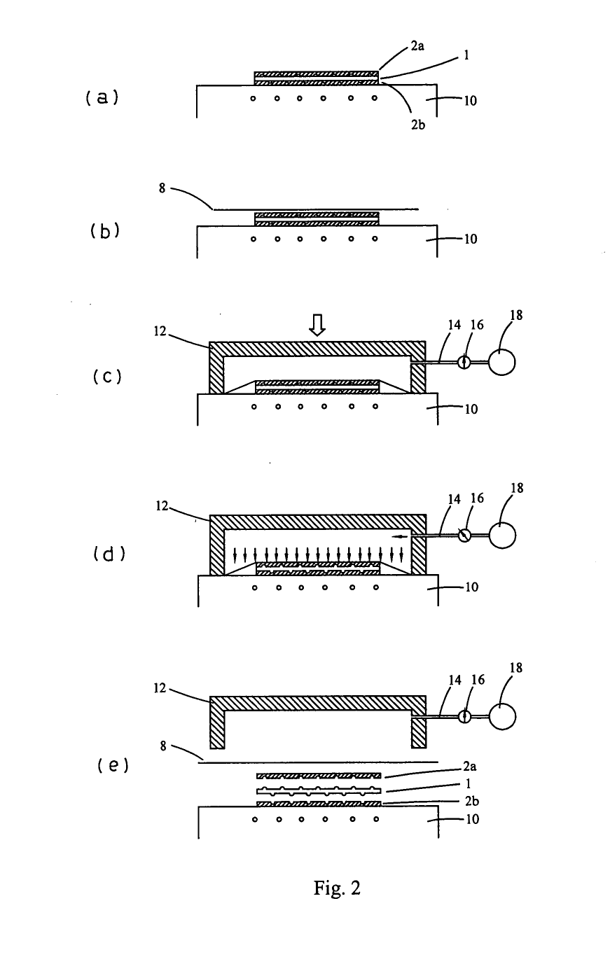

FIGS. 2(a) to 2(e) show steps for simultaneously forming microstructures on two surfaces of an object according to the second embodiment of the present invention. As shown in FIG. 2(a), an object 1 such as a plastic film is sandwiched by an upper mold 2a and a lower mold 2b in such a manner that surfaces of these two molds having microstructures are in contact with the object and face to each other. This stack of upper mold/plastic film/lower mold is placed on the platform 10.

Thereafter, a sheet of sealing film 8 is laid on this stack as show in FIG. 2(b), and its edge portions is pressed against the platform 10 by a chamber 12 so that the sealing film/upper mold/plastic film/lower mold is enclosed by the chamber 12 as shown in FIG. 2(c).

The chamber 12 is driven by hydraulic means or a crank (not shown) so as to be quick opened and closed. This chamber 12 is connected to a pressurized fluid source 18 and a pressure control valve 16 through a conduit 14. As mentioned above, the pressurized fluid source 18 can supply heated and pressurized fluid.

The heated and pressurized fluid from the pressurized fluid source 18 is then regulated by the pressure control valve 16 up to a pressure sufficient to emboss the plastic film 1, for example, 0.5 to 350 kgf/cm², as shown in FIG. 2(d). Since the temperature of the pressurized fluid is high enough to heat the plastic film 1 to its glass transient temperature or above, the plastic film 1 is heated to become thermoplastic by the heated and pressurized fluid being introduced into the chamber 12. The plastic film 1 which became soft fills into cavities in the mold in the pressurized fluid for a time period, and then is cooled, while sustaining the pressure of the fluid substantially constant. During the cooling step, as shown in FIG. 4, a coolant such as cooling water may flow through the conduit 100 provided in the platform or the chamber.

Preferably, the time period for embossing is between 10 seconds and 30 minutes. The glass transient temperature of the sealing film 8 is preferable higher than that of the plastic film 1 functioning as the object.

After replicating microstructures from the molds to the plastic film 1, the fluid will be drained out under control of the pressure control valve 16, and then the chamber is opened for taking out the resultant product, as shown in FIG. 2(e).

Embodiment 3

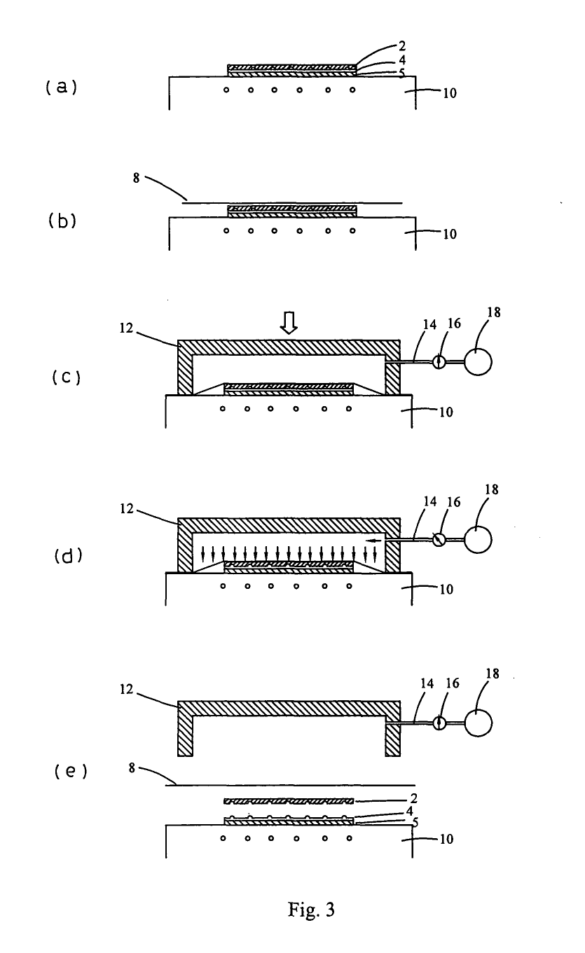

FIGS. 3(a) to 3(e) show steps for molding micro structures according to the third embodiment of the present invention, which can quick heat/cool an object to be embossed and apply uniform pressure to the object. As shown in FIG. 3(a), a polymer-containing solution is applied to a substrate 5 such as silicon wafer, and then is hardened by baking so as to form a layer 4 to be embossed. Subsequently, on an operation platform, a mold 2 is placed on the layer 4 so as to form a stack of mold/silicon wafer in a manner that its one surface 2 on which microstructures are formed is in contact with the layer 4.

Thereafter, as shown in FIG. 3(b), one sheet of sealing film 8 is laid on this stack to form another stack of sealing film/mold/substrate. As discussed later, the sealing film 8 cooperates with a chamber for embossing the object.

As shown in FIG. 3(c), edge portions of the sealing film are pressed against the platform 10 by the chamber 12 so that the stack of sealing film/mold/silicon wafer is enclosed by the chamber 12. The chamber 12 is driven by hydraulic means or a crank (not shown) so as to be quick opened and closed. This chamber 12 is connected to a pressure control valve 16 and a pressurized fluid source 18 through a conduit 14. As mentioned above, the pressurized fluid source 18 can supply heated and pressurized fluid.

The heated and pressurized fluid from the pressurized fluid source 18 is regulated by the pressure control valve 16 up to a pressure sufficient to emboss the layer 4, for example, 0.5 to 350 kgf/cm², as shown in FIG. 3(d). Since the temperature of the pressurized fluid is high enough to heat the layer 4 to its glass transient temperature or above, the layer 4 is heated to become thermoplastic by the heated and pressurized fluid being introduced into the chamber 12. The layer 4 which became soft fills into cavities in the mold under the pressurized fluid for a time period, and then is cooled, while sustaining the pressure of the fluid substantially constant. During the cooling step, as shown in FIG. 4, a coolant such as cooling water may flow through the conduit 100 provided in the platform or the chamber.

Embodiment 4

Since the present embodiment is different from the above embodiments in the control of the temperature of a pressurized fluid such as hot oil, the similar steps will not be explained for simplicity. According to the present embodiment, before being introduced into the chamber 12, the pressurized fluid will be heated to a first temperature. After being introduced into the chamber 12, the pressurized fluid will be reheated by a high temperature fluid flowing through the conduit 100 provided in the chamber 12 so as to reach a second temperature higher than the transient temperature of an object to be embossed. After being heated to or above the transient temperature, the object becomes thermoplastic for embossing. The present embodiment can be freely combined with any one of the above embodiments 1 to 3.

Embodiment 5

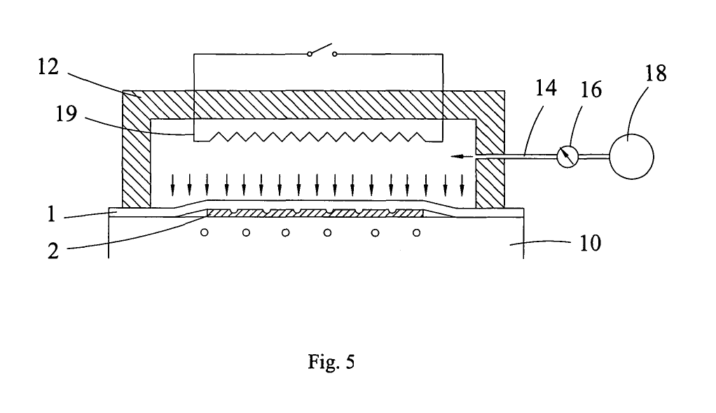

In the above embodiments, a heated and pressurized fluid is introduced into a chamber for embossing, but the present embodiment uses an unheated pressurized fluid. According to the present embodiment, as shown in FIG. 5, an object 1 is heated by a radiation heater 19 provided in a chamber to or above its glass transient temperature, and then a pressurized but non-heated fluid is introduced into the chamber for embossing the object 1. For example, the radiation heater may be a far infrared radiation heater, high frequency heater, UV light heater, or a halogen light, and may be provided inside or outside of the chamber 12. The present embodiment can be freely combined with any one of the above embodiments 1-4.

It is understood that while the invention has been described in conjunction with the detailed description thereof, the foregoing description is intended to illustrate and not limit the scope of the present invention, which is defined by the scope the appended claims.

Effects and advantages of the present invention are summarized as follows.

1. Since an object to be embossed is directly heated/cooled by a fluid or a radiation heater, the present invention has effects that the time period for heating/cooling the object, and consumed energy can be significantly reduced.

2. According to the present invention, a heated fluid is employed to directly emboss an object without using any actuator and/or pressing means. Owing to the isotropic property and equal distribution of fluid properties, the present invention can uniformly emboss an object in very large area for embossing. For example, the present invention can be applied to emboss an object having a radius such as 4 inches, 6 inches, 8 inches, 12 inches or above.

3. In the conventional technologies, a mold made of bristle material such as glass, or silicon has to be electroplated with a metal prior to embossing. However, the present invention can use a mold made of bristle but non-electroplated for embossing. Therefore, in comparison with the conventional technologies, the present invention has advantages that the number of steps, process time, cost, and energy for embossing can be reduced.

4. The present invention can emboss two surfaces of an object simultaneously and hence has a great flexibility in fabrication of microstructures.

1. A hot embossing method, which can quick heat and cool, and apply uniform pressure onto an object being closely placed against a mold in a sealed chamber, the method being characterized in that the sealed chamber is separated into a first space and a second space by the object in such a manner that the object and the mold are inside the second space, and a high pressure fluid is introduced into the first space when the object is heated to be thermoplastic, thereby to replicate a microstructure formed on the mold onto the object by means of the pressure of the high pressure fluid without using a pressing mechanism.

2. A method as claimed in claim 1, further comprising a step for cooling the object and the mold by flowing a coolant into a conduit provided in the sealed chamber after the high pressure fluid directly presses the object against the mold.

3. A method as claimed in claim 1, wherein the high pressure fluid is heated to a temperature sufficient to make the object thermoplastic.

4. A method as claimed in claim 1, wherein the high pressure fluid is heated to a temperature before being introduced into the sealed chamber, and after being introduced into the chamber, the high pressure fluid is reheated to a second temperature by a high temperature fluid flowing through a conduit provided in the chamber so as to heat the object to be thermoplastic.

5. A method as claimed in claim 1, wherein the object is heated to be thermoplastic by a radiation heater provided inside the chamber.

6. A method as claimed in claim 1, wherein the radiation heater is selected from a group consisting of a far infrared heater, a high frequency heater, a UV heater, and a halogen light.

7. A method as claimed in claim 1, wherein the high pressure fluid has a pressure in a range between 0.5 kgf/cm² and 350 kgf/cm², and the object is embossed for a time period from 10 seconds to 30 minutes.

8. A method as claimed in claim 1, wherein the object is one of a plastic film and a metal foil.

9. A method as claimed in claim 1, wherein the high pressure fluid is selected form a group consisting of steam, oil, air, water, inert gas, nitrogen, and combinations thereof.

10. A hot embossing method for forming microstructures onto both surfaces of an object, which can quick heat and cool, and apply uniform pressure onto an object, the method being characterized in that the object is sandwiched by two separate molds to form an assembly to be embossed, a sealing film covers the assembly, a chamber presses against the edge parts of the sealing film to enclose the sealing film and the assembly therein in such a manner that a space inside the chamber is separated into a first space and a second space by the sealing film and the assembly is located inside the second space, and a high pressure fluid is introduced into the first space when the object is heated to be thermoplastic, thereby to simultaneously replicate the microstructures of the two molds onto both surfaces of the object by means of the pressure of the high pressure fluid without using a pressing mechanism.

11. A method as claimed in claim 10, further comprising a step for cooling the object and the mold by flowing a coolant into a conduit provided in the sealed chamber after the high pressure fluid directly presses the object against the mold.

12. A method as claimed in claim 10, wherein the high pressure fluid is heated to a temperature sufficient to make the object thermoplastic.

13. A method as claimed in claim 10, wherein the high pressure fluid is heated to a temperature before being introduced into the sealed chamber, and after being introduced into the chamber, the high pressure fluid is reheated to a second temperature by a high temperature fluid flowing through a conduit provided in the chamber so as to heat the object to be thermoplastic.

14. A method as claimed in claim 10, wherein the object is heated to be thermoplastic by a radiation heater provided inside the chamber.

15. A method as claimed in claim 14, wherein the radiation heater is selected from a group consisting of a far infrared heater, a high frequency heater, a UV heater, and a halogen light.

16. A method as claimed in claim 10, wherein the high pressure fluid has a pressure in a range between 0.5 kgf/cm² and 350 kgf/cm², and the object is embossed for a time period from 10 seconds to 30 minutes.

17. A method as claimed in claim 10, wherein the object is selected from a group consisting of a plastic sheet, a metal foil, a ceramic sheet and a polymer coated on a substrate.

18. A method as claimed in claim 17, wherein the substrate is selected from a group consisting of a silicon wafer, a plastic plate, a glass plate.

19. A method as claimed in claim 10, wherein the sealing film is one of a plastic film or a metal foil.

20. A method as claimed in claim 10, wherein the high pressure fluid is selected form a group consisting of steam, oil, air, water, inert gas, nitrogen, and combinations thereof.
